(19) United States
(12) Patent Application Publication
(10) Pub. No.: US 2026/0254211 A1
(43) Pub. Date: Aug. 27, 2026

(54) PROTECTOR AND WIRING HARNESS ROUTING STRUCTURE

(71) Applicant: SUMITOMO WIRING SYSTEMS, LTD., Mie (JP)

(72) Inventor: Koichi YAMAZAKI, Mie (JP)

(21) Appl. No.: 19/539,534

(22) Filed: Feb. 13, 2026

(30) Foreign Application Priority Data
Feb. 21, 2025 (JP) 2025-027317

(51) Int. Cl. H02G 3/04

(52) U.S. Cl. CPC H02G 3/0418

(57) ABSTRACT

A protector provided with a duct-like storage space in which a wiring harness is disposed includes a main body having an upward opening, a first cover that covers part of the upward opening, and a second cover that covers the remaining part of the upward opening. The storage space includes a first space enclosed by the main body and the first cover and in which a connector of the wiring harness is disposed, and a second space enclosed by the main body and the second cover and into which a wire that is connected to the connector is inserted. The second cover includes a drainage channel formed along a boundary line between the first cover and the second cover.

### CROSS-REFERENCE TO RELATED APPLICATIONS

This application is based on and claims priority from Japanese Patent Application No. 2025-027317, filed on Feb. 21, 2025, with the Japan Patent Office, the disclosure of which is incorporated herein in its entirety by reference.

### TECHNICAL FIELD

The present disclosure relates to a protector and a routing structure for a wiring harness.

### BACKGROUND

JP 2021-078168 A discloses a protector that protects a wiring harness installed in a vehicle such as an automobile. Routing material constituting the wiring harness can be protected from constituent members of the vehicle and the like by attaching a protector to the routing material. The routing material is, for example, a wire with connector having a connector at an end portion of the wire. The protector is provided with a protector main body that has an upward opening and a cover member that blocks the opening in the protector main body. After disposing the wiring harness in a storage space of the protector main body, the wiring harness can be protected by the protector, by closing the storage space with the cover member.

### SUMMARY

A connector provided in a wiring harness protected by a protector is, for example, connected to another connector provided in another wiring harness. If the connection point between the two connectors is not fixed to an immovable member, high stress could possibly act on the connection point between the two connectors due to vibration during vehicle use and the like. While high stress acting on the connection point between the two connectors can conceivably be reduced by fixing the connectors inside the protector, insufficient consideration has been given to a configuration that allows the connectors to be easily disposed at a predetermined position in the protector.

Also, depending on the position at which the protector is disposed in the vehicle, liquid may get onto the protector from above the protector. For example, if the protector is disposed below the floor near a center console, a drink spilled from a cup holder could possibly get onto the protector. Thus, when employing a configuration that fixes the connector inside the protector, the possibility of liquid on the protector getting inside the protector and reaching the connector needs to be reduced.

One object of the present disclosure is to provide a protector that enables a connector of a wiring harness to be fixed inside thereof and has excellent waterproofness. Another object of the present disclosure is to provide a routing structure for a wiring harness that includes the protector.

A protector of the present disclosure is a protector provided with a duct-like storage space in which a wiring harness is to be disposed, and includes a main body having an upward opening, a first cover that covers a part of the upward opening, and a second cover that covers a remaining part of the upward opening. The storage space includes a first space enclosed by the main body and the first cover and in which a connector of the wiring harness is to be disposed, and a second space enclosed by the main body and the second cover and into which a wire that connects to the connector is to be inserted. The second cover includes a drainage channel formed along a boundary line between the first cover and the second cover.

The protector of the present disclosure enables a connector of a wiring harness to be fixed inside thereof and has excellent waterproofness.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a schematic perspective view of a routing structure for a wiring harness according to a first embodiment.

FIG. 2 is a schematic perspective view of part of the wiring harness routing structure shown in FIG. 1 from a different angle to FIG. 1.

FIG. 3 is an exploded perspective view of the wiring harness routing structure shown in FIG. 1.

FIG. 4 is an enlarged side view of the vicinity of a boundary between a first cover and a second cover in the wiring harness routing structure shown in FIG. 1.

FIG. 5 is a partially enlarged cross-sectional view of a protector according to a second embodiment.

FIG. 6 is a partially enlarged cross-sectional view of a protector according to a third embodiment.

FIG. 7 is a partially enlarged cross-sectional view of a protector according to a fourth embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Disclosure

First, embodiments of the present disclosure will be enumerated and described.

[1] A protector of the present disclosure is a protector provided with a duct-like storage space in which a wiring harness is to be disposed, and includes a main body having an upward opening, a first cover that covers a part of the upward opening, and a second cover that covers a remaining part of the upward opening. The storage space includes a first space enclosed by the main body and the first cover and in which a connector of the wiring harness is to be disposed, and a second space enclosed by the main body and the second cover and into which a wire that connects to the connector is to be inserted. The second cover includes a drainage channel formed along a boundary line between the first cover and the second cover.

In the above protector, the first cover forming the first space in which the connector of the wiring harness is to be disposed and the second cover forming the second space in which the wire of the wiring harness is to be disposed are independent members. Thus, the first space and the second space can be closed separately. For example, after disposing the wire in the main body of the protector and closing the second cover to fix the position of the wire, the disposition state of the connector with respect to the main body of the protector can be checked. After checking the disposition state of the connector, the connector is securely fixed at a predetermined position with respect to the protector by closing the first cover.

The connecting part of the connector and the wire and the connecting part of the connector and another connector are disposed in the first space. In the case where liquid gets onto the second cover from above the second cover, liquid could possibly get onto the connecting parts if liquid gets into the first space from the boundary line between the second cover and the first cover. With the protector described in <1> above, liquid is unlikely to get into the first space, due to the second cover being provided with a drainage channel in which liquid flows along the boundary line. Thus, the possibility of liquid getting onto the connecting parts can be greatly reduced.

[2] In the protector according to [1] above, one of the first cover and the second cover may have a rib along the boundary line, and the other of the first cover and the second cover may have a rib cover that engages the rib from above the rib. A cross-sectional shape of the rib cover orthogonal to a direction along a length of the rib may be an inverted U-shape. The drainage channel may be formed along an outer peripheral surface of the rib cover.

A water stop structure is formed by the rib and the rib cover engaging each other. A recess part into which the rib is fitted is formed in the rib cover which has an inverted U-shaped cross-sectional shape. The gap between the rib and the rib cover is narrow, making ingress of liquid unlikely. Accordingly, liquid on the second cover is unlikely to get into the storage space of the protector through the gap between the rib and the rib cover.

[3] In the protector according to [2] above, the rib may be formed on the second cover, and the rib cover may be formed on the first cover.

When disposing the wiring harness in the protector, the connector is easily disposed at a predetermined position in the protector, by disposing the wire in the second space and closing the second cover to fix the position of the wire, and then positioning the connector in the first space. In other words, if the rib cover that is engaged with the rib from above is formed on the first cover, the first cover can be closed after the second cover.

[4] In the protector according to any of [1] to [3] above, the first cover may be connected to the main body by a hinge part and be openable and closeable with respect to the main body.

If the first cover is attached to the main body by the hinge part, the main body and the first cover can be molded with a single mold. The number of molds for molding the protector is thereby kept low.

[5] A wiring harness routing structure according to an embodiment includes a wiring harness and a protector including a duct-like storage space in which the wiring harness is disposed. The protector includes a main body having an upward opening, a first cover that covers a part of the upward opening, and a second cover that covers a remaining part of the upward opening. The storage space includes a first space enclosed by the main body and the first cover and in which a connector of the wiring harness is disposed, and a second space enclosed by the main body and the second cover and into which a wire that connects to the connector is inserted. The second cover includes a drainage channel formed along a boundary line between the first cover and the second cover.

In the above wiring harness routing structure, the first cover forming the first space in which the connector of the wiring harness is disposed and the second cover forming the second space in which the wire of the wiring harness is disposed are independent members. Thus, the first space and the second space can be closed separately. For example, after disposing the wire in the main body of the protector and closing the second cover to fix the position of the wire, the disposition state of the connector with respect to the main body of the protector can be checked. After checking the disposition state of the connector, the connector is securely fixed at a predetermined position with respect to the protector by closing the first cover.

With the protector provided in the above wiring harness routing structure, liquid is unlikely to get into the first space, due to the second cover being provided with a drainage channel in which liquid flows along the boundary line. Thus, the possibility of liquid getting onto the connecting part of the connector and the wire and the connecting part of the connector and another connector can be greatly reduced.

### Detailed Description of Embodiments of the Disclosure

Hereinafter, embodiments of a protector and a routing structure for a wiring harness of the present disclosure will be described based on the drawings. The same reference signs in the diagrams indicate constituent elements of the same name. Note that the present invention is not limited to the configurations shown in the embodiments and is indicated by the claims, and all changes that come within the meaning and range of equivalency of the claims are intended to be embraced therein.

### First Embodiment

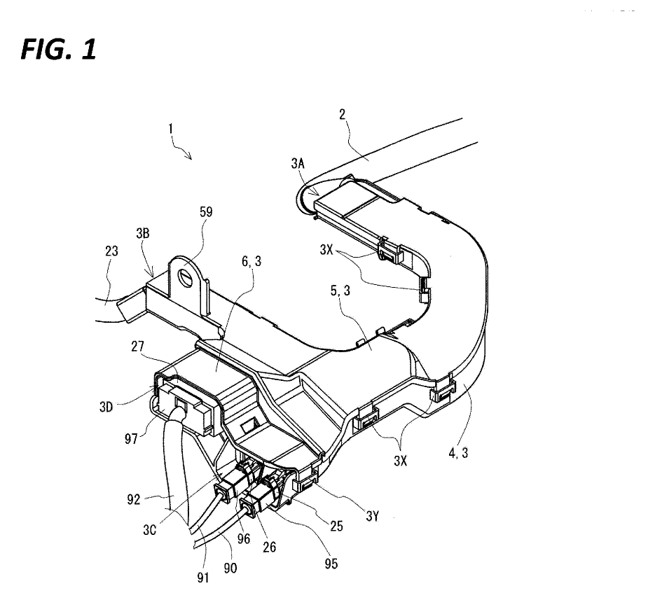

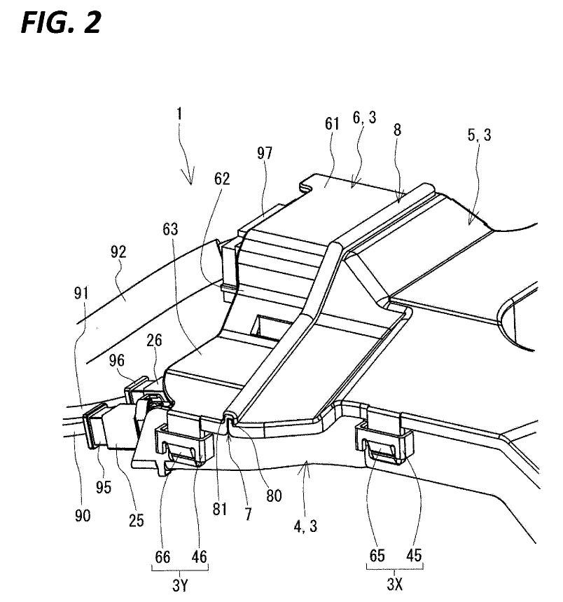

A routing structure 1 for a wiring harness shown in FIGS. 1 and 2 is provided with a wiring harness 2 and a protector 3 that are installed in a vehicle. One of the characteristics of the wiring harness routing structure 1 of the present example is being provided with a structure in which connectors 25 and 26 of the wiring harness 2 are disposed inside the protector 3, and, even if liquid gets onto the protector 3, the liquid is unlikely to reach the connectors 25 and 26. Hereinafter, the wiring harness routing structure 1 will simply be referred to as the routing structure 1, and configurations of the routing structure 1 will be described.

### Wiring Harness

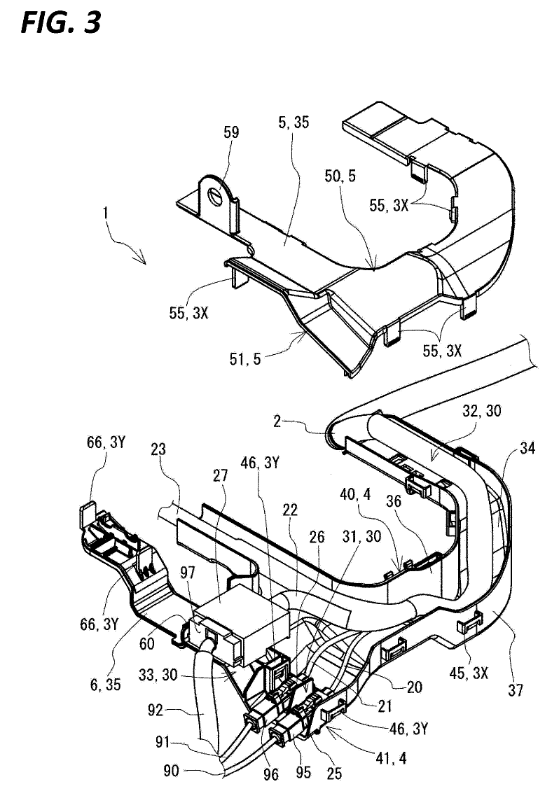

As shown in the exploded perspective view of FIG. 3, the wiring harness 2 is a wiring member in which a plurality of wires 20, 21, 22, and 23 are bound together with tape or the like. The wiring harness 2 of the present example is provided with two small diameter wires 20 and 21 and two large diameter wires 22 and 23. In the present example, the four wires 20, 21, 22, and 23 branch out in a storage space 30 formed inside the protector 3. The connectors 25 and 26 are attached to end portions of the small diameter wires 20 and 21. A connector 27 is attached to an end portion of the large diameter wire 22. The end portion of the large diameter wire 23 is not illustrated.

Connectors 95, 96, and 97 that are provided in another wiring harness are connected to the connectors 25, 26, and 27. The other wiring harness is a wiring member in which a plurality of wires 90, 91, and 92 provided with the connectors 95, 96, and 97 are bound together.

The connectors 25, 26, and 27 are fixed to the protector 3 which will be described later. The connectors 25 and 26 are smaller than the connector 27, and are difficult to stably fix to the protector 3. The connectors 25 and 26 have the same structure as each other. For the fixing structure of the connectors 25 and 26, a well-known fixing structure, such as an engaging structure between a rail and a slider, for example, can be employed.

### Protector

The protector 3 is, for example, formed with an insulating material such as resin. The protector 3 is, for example, manufactured by resin molding. The resin is, for example, polyethylene terephthalate resin. The resin may contain an insulating filler or the like.

The protector 3 is provided with the storage space 30, which is a duct-like space in which the wiring harness 2 is disposed. The storage space 30 is provided with a first space 31 in which the small connectors 25 and 26 of the wiring harness 2 are disposed, and a second space 32 in which the wires 20, 21, 22, and 23 are disposed. Furthermore, the protector 3 of the present example is provided with a third space 33 in which the large connector 27 of the wiring harness 2 is disposed. The first space 31, the second space 32, and the third space 33 are connected to each other.

The second space 32 is an approximately U-shaped space, and both end portions of the U-shape open toward the upper left in FIGS. 1 and 3. These two end portions form openings 3A and 3B of the protector 3, as shown in FIG. 1. The opening 3A is a hole for leading the wiring harness 2 out from inside the protector 3. The opening 3B is a hole for leading the wire 23 of the wiring harness 2 out from inside the protector 3.

The first space 31 and the third space 33 shown in FIG. 3 branch from the vicinity of the bend portion of the U-shape of the second space 32. The end portions of the first space 31 and the third space 33 on the opposite side to the portions connected to the second space 32 open toward the lower left in FIGS. 1 and 3. These end portions of the first space 31 and the third space 33 respectively form an opening 3C and an opening 3D of the protector 3, as shown in FIG. 1. The opening 3C is a hole that exposes the end portions of the connectors 25 and 26 to outside of the protector 3. Exposing the connectors 25 and 26 through the opening 3C allows the connectors 25 and 26 to be connected to the other connectors 95 and 96. Also, the opening 3D is a hole that exposes the end portion of the connector 27 to outside of the protector 3. Exposing the connector 27 through the opening 3D allows the connector 27 to be connected to the other connector 97.

The connection between the connector 25 and the other connector 95 and the connection between the connector 26 and the other connector 96 is maintained by a locking mechanism. The locking mechanism is a known configuration in which the two connectors 25 and 95 or the two connectors 26 and 96 are connected to each other by mechanical fitting, and a detailed description thereof is omitted herein.

The protector 3 is provided with a bottom surface part 34, a top surface part 35, and lateral surface parts 36 and 37 that form the storage space 30. The bottom surface part 34 is a portion that is disposed downward in the vehicle. The top surface part 35 is a portion that is disposed upward in the vehicle and faces the bottom surface part 34. The lateral surface parts 36 and 37 are wall parts that connect the bottom surface part 34 to the top surface part 35. The protector 3 provided with the bottom surface part 34, the top surface part 35, and the lateral surface parts 36 and 37 is constituted by combining a plurality of members. The plurality of members in the present example are a main body 4, a first cover 6, and a second cover 5.

### Main Body

The main body 4 is constituted by the bottom surface part 34 and the lateral surface parts 36 and 37. The main body 4 is provided with a drainpipe-shaped routing part 40 that is formed to be approximately U-shaped and a gate part 41 that branches from the vicinity of the bend portion of the U-shape of the routing part 40. The routing part 40 is the portion that forms the second space 32 described above, and the portion through which the wires 20, 21, 22, and 23 are routed. The gate part 41 is the portion that forms the first space 31 and the third space 33, and the portion in which the connectors 25, 26, and 27 are disposed.

### First Cover

The first cover 6 is constituted by the portions of the top surface part 35 that form the first space 31 and the third space 33. The first cover 6 is connected to the main body 4 by a hinge part 60 and is openable and closeable with respect to the main body 4. The hinge part 60 is formed on a lateral part of the third space 33 that is on the opposite side to the first space 31. FIG. 3 shows a state in which the first cover 6 is open.

As shown in FIG. 2, the first cover 6 is provided with a first portion 61, a bend part 62, and a second portion 63. The first portion 61 is connected to the hinge part 60 (see FIG. 3) and is the portion that covers the connector 27 from above when the first cover 6 is closed. The second portion 63 is the portion that covers the connectors 25 and 26 from above. The bend part 62 is the portion that connects the first portion 61 to the second portion 63. An engaging claw 66 is formed on the inner surface of the bend part 62, as shown in FIG. 3. The engaging claw 66 constitutes part of an engaging part 3Y, which will be described later.

The closed first cover 6 is engaged with the main body 4 by the engaging part 3Y which has a snap-fit structure. The engaging part 3Y of the present example is constituted by the engaging claw 66 formed on the first cover 6 and an annular fastener 46 formed on the main body 4. The engaging claw 66 is formed on the inner surface of the bend part 62 (FIG. 2) and the end portion of the second portion 63. On the other hand, two fasteners 46 are formed at positions that sandwich the first space 31 (FIG. 3). As an alternative configuration to the present example, the engaging claw 66 may be formed on the main body 4 and the fastener 46 may be formed on the first cover 6.

Due to the first cover 6 being openable and closeable with respect to the main body 4, the connectors 25 and 26 can be disposed in the first space 31 in a state where the first cover 6 constituting part of the top surface part 35 is open. Thus, since the top surface part 35 does not interfere with disposition of the connectors 25 and 26 into the first space 31, the connectors 25 and 26 are easily disposed in the first space 31.

If the main body 4 and the first cover 6 are integrally formed by being connected by the hinge part 60, the main body 4 and the first cover 6 can be molded with a single mold. In other words, there is no need to mold the main body 4 and the first cover 6 with separate molds, and productivity of the protector 3 improves.

### Second Cover

As shown in FIG. 3, the second cover 5 is constituted by the portion of the top surface part 35 that forms the second space 32. The second cover 5 is provided with a main part 50 that covers the routing part 40 of the main body 4 and an eave part 51 that covers the gate part 41 of the main body 4. The main part 50 is a generally U-shaped plate material. A bracket part 59 is formed in the vicinity of one of the end portions of the U-shape of the main part 50. The bracket part 59 is a plate-like piece that extends upward and has a threaded hole. The bracket part 59 is utilized when fixing the protector 3 to a frame or the like of the vehicle (not shown).

The eave part 51 is a plate material that extends outward from the vicinity of the bend part of the U-shape of the main part 50. The portion of the eave part 51 that faces the first space 31 is substantially parallel to the bottom surface part 34 in the first space 31. The portion of the eave part 51 that faces the third space 33 slopes upward proceeding away from the main part 50.

The second cover 5 is configured to be attachable and detachable with respect to the main body 4. The second cover 5 and the main body 4 are engaged with each other by an engaging part 3X having a snap-fit structure. The engaging part 3X of the present example is constituted by an engaging claw 55 formed on the second cover 5 and an annular fastener 45 formed on the main body 4. The main body 4 and the second cover 5 are engaged with each other by the claw part of the engaging claw 55 inserted into the fastener 45 hooking onto the fastener 45. As an alternative configuration to the present example, the engaging claw 55 may be formed on the main body 4 and the fastener 45 may be formed on the second cover 5.

Due to the second cover 5 being attachable and detachable with respect to the main body 4, the wires 20, 21, 22, and 23 can be disposed in the routing part 40 of the main body 4 which is the second space 32 in a state where the second cover 5 constituting the top surface part 35 is removed. Thus, since the top surface part 35 does not interfere with disposition of the wires 20, 21, 22, and 23 into the second space 32, the wires 20, 21, 22, and 23 are easily disposed in the second space 32.

### Water Stop Structure

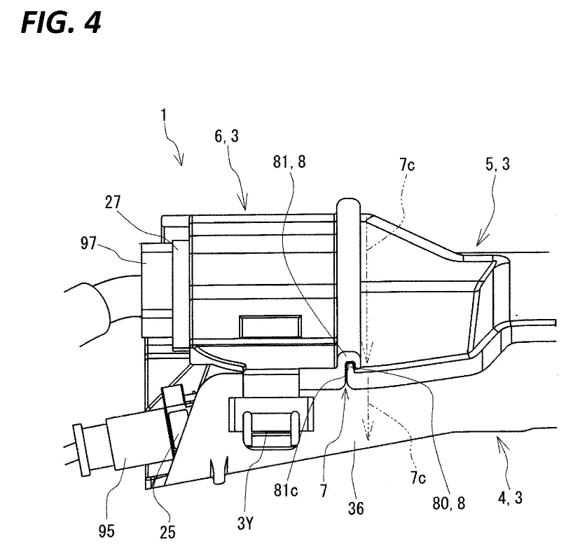

Depending on the disposition position of the protector 3 in the vehicle, liquid may get onto the protector 3 from above the protector 3. As shown in the side view of FIG. 4, in the routing structure 1 of the present example that covers the upward opening in the main body 4 with the independent first and second covers 6 and 5, liquid could possibly get into the storage space 30 (FIG. 3) from the position of the boundary line 7 where the first cover 6 and the second cover 5 abut against each other. The boundary line 7 in the present example means the edge portions of the first cover 6 and the second cover 5 where the first cover 6 and the second cover 5 face each other. In the routing structure 1 of the present example, a water stop structure 8 that reduces ingress of liquid into the storage space 30 from the boundary line 7 is formed.

The water stop structure 8 of the present example is constituted by a rib 80 formed on the second cover 5 along the boundary line 7 and a rib cover 81 formed on the first cover 6 along the boundary line 7. The cross-sectional shape of the rib cover 81 orthogonal to the length of the rib 80 is an inverted U-shape. The rib cover 81 is provided with a recess part 81c that engages the rib 80 from above the rib 80.

With the water stop structure 8 of the present example, even if liquid that has dropped onto the second cover 5 from above moves toward the first cover 6, the liquid is blocked by the outer peripheral surface of the rib cover 81. The liquid blocked by the rib cover 81 is unlikely to move up and over the rib cover 81 to the first cover 6, and, as indicated by the long dashed double-dotted line, the liquid readily moves in a direction along the length of the rib cover 81. In other words, a drainage channel 7c is formed on the outer side of the portion of the outer peripheral surface of the rib cover 81 on the second cover 5 side. The liquid that reaches the edge portion of the second cover 5 on the near side in FIG. 4 along the rib cover 81 drops downward along the outer periphery of the lateral surface part 36 of the main body 4, as indicated by the short dashed double-dotted line.

The water stop structure 8 of the present example has a fitting structure in which the rib 80 fits into the recess part 81c of the rib cover 81, and thus liquid is unlikely to get in between the rib cover 81 and the rib 80. Even if liquid does get into the gap between the rib cover 81 and the rib 80, the rib 80 serves as a wall and the liquid is unlikely to move to the first cover 6 side beyond the rib 80.

As mentioned above, with the water stop structure 8 of the present example, liquid is unlikely to get inside the protector 3 from the position of the boundary line 7. Accordingly, liquid is also unlikely to get onto the connector 25 disposed inside the protector 3.

### Second Embodiment

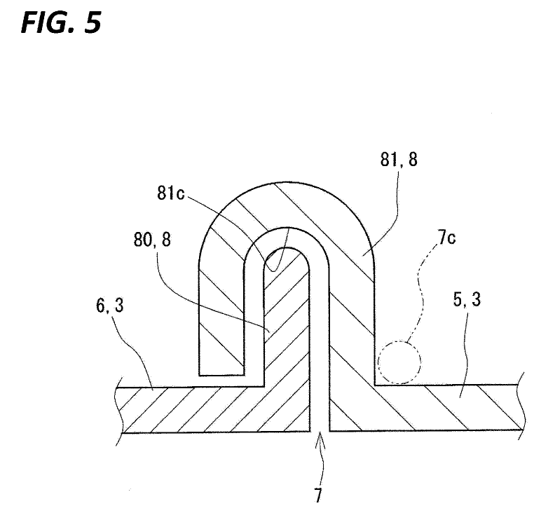

In the second embodiment, a protector 3 having a water stop structure 8 that differs from the first embodiment will be described based on FIG. 5.

The rib 80 of the water stop structure 8 of the present example is formed on the first cover 6, and the rib cover 81 is formed on the second cover 5. In this case, the drainage channel 7c is formed on the outer side of the rib cover 81 formed on the second cover 5. With this configuration, liquid cannot get into the gap between the rib cover 81 and the rib 80 without getting over the rib cover 81. Thus, the configuration of the second embodiment is less prone to ingress of liquid into the protector 3 from the position of the boundary line 7 than the configuration of the first embodiment.

### Third Embodiment

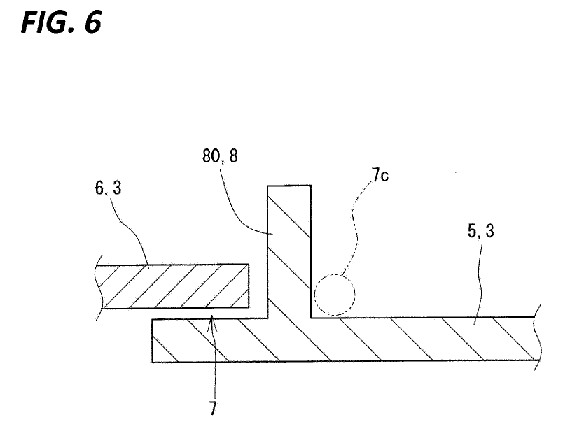

In the third embodiment, a protector 3 having a water stop structure 8 that differs from the first and second embodiments will be described based on FIG. 6.

In the present example, the edge portion of the first cover 6 overlaps the edge portion of the second cover 5 from above. With this configuration, the boundary line 7 is formed between the lower surface of the first cover 6 and the upper surface of the second cover 5 in the overlapping portion.

The water stop structure 8 of the present example is provided with only the rib 80 formed on the second cover 5. Due to the rib 80 being formed on the second cover 5, the drainage channel 7c is formed on the outer side of the surface of the rib 80 that faces the opposite side to the first cover 6. Liquid cannot reach the boundary line 7 without getting over the rib 80, and thus ingress of liquid into the protector 3 is also unlikely with this configuration.

### Fourth Embodiment

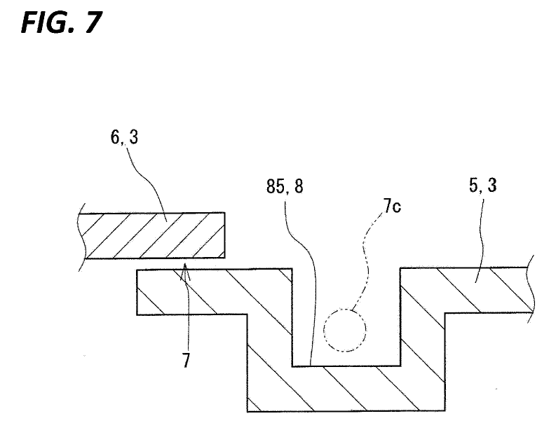

In the fourth embodiment, a protector 3 having a water stop structure 8 that differs from the first to third embodiments will be described based on FIG. 7.

The water stop structure 8 of the present example is constituted by a groove 85 formed in the second cover 5. In this case, the groove 85 serves as the drainage channel 7c, allowing liquid to run off, and thus liquid is unlikely to reach the boundary line 7. As a result, liquid is unlikely to get inside the protector 3.

The configuration of the third embodiment and the configuration of the fourth embodiment may be combined. Specifically, the groove 85 shown in FIG. 7 may be formed on the right side of the rib 80 in FIG. 6, that is, on the opposite side to the boundary line 7 with the rib 80 sandwiched therebetween.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A protector including a duct-like storage space in which a wiring harness is to be disposed, comprising:
a main body having an upward opening;
a first cover that covers a part of the upward opening; and
a second cover that covers a remaining part of the upward opening;
wherein the storage space includes
a first space enclosed by the main body and the first cover and in which a connector of the wiring harness is to be disposed; and
a second space enclosed by the main body and the second cover and into which a wire that connects to the connector is to be inserted, and
the second cover includes a drainage channel formed along a boundary line between the first cover and the second cover.

2. The protector according to claim 1,
wherein one of the first cover and the second cover has a rib along the boundary line, and the other of the first cover and the second cover has a rib cover that engages the rib from above the rib,
a cross-sectional shape of the rib cover orthogonal to a direction along a length of the rib is an inverted U-shape, and
the drainage channel is formed along an outer peripheral surface of the rib cover.

3. The protector according to claim 2,
wherein the rib is formed on the second cover, and the rib cover is formed on the first cover.

4. The protector according to claim 1,
wherein the first cover is connected to the main body by a hinge part and is openable and closeable with respect to the main body.

5. A wiring harness routing structure comprising:
a wiring harness; and
a protector including a duct-like storage space in which the wiring harness is disposed,
wherein the protector includes
a main body having an upward opening;
a first cover that covers a part of the upward opening; and
a second cover that covers a remaining part of the upward opening,
the storage space includes
a first space enclosed by the main body and the first cover and in which a connector of the wiring harness is disposed;
a second space enclosed by the main body and the second cover and into which a wire that connects to the connector is inserted, and
the second cover includes a drainage channel formed along a boundary line between the first cover and the second cover.
